(19) United States
(12) Patent Application Publication
(10) Pub. No.: US 2013/0087676 A1
(43) Pub. Date: Apr. 11, 2013

(54) Carry and Display Case

(71) Applicant: Curtis L. Stallworth, Bronx, NY (US)

(72) Inventor: Curtis L. Stallworth, Bronx, NY (US)

(21) Appl. No.: 13/631,902

(22) Filed: Sep. 29, 2012

Related U.S. Application Data
(60) Provisional application No. 61/541,382, filed on Sep. 30, 2011.

(51) Int. Cl. F16M 13/00

(52) U.S. Cl. CPC F16M 13/00
USPC 248/558

(57) ABSTRACT

Lightweight protective case that allows a user to adhere an article, held within the carrying case with bracket, to various surfaces including but not limited to: a surface that is covered with fabric, a complementary hook and loop surface or a surface that allows for the affixing of the case's suspension strap, and achieve maximum productivity and utilization of the article while the article continues to be held within the carrying case. As well, one is able to use the case as the case sits on a horizontal surface. An article that is used with the case can also be utilized in a landscape or portrait orientation. The present invention also enables the user to take advantage of many of the features of various articles without having to actually hold on to the article. Furthermore, the present invention can also be used with a variety of articles, thus eliminating the need to purchase multiple cases for various articles. Also, the present invention is bendable and highly flexible.

The application claims the benefit under 35 U.S.C. 119 of U.S. Provisional Application No. 61541382, filed Sep. 30, 2011 by Curtis Stallworth and is incorporated herein by reference.

### FIELD OF THE INVENTION

The present invention relates to the technical field of package and article carriers. More particularly, the present invention is in the technical field of carry and display articles that are configured to allow for the carry, display and protection of various items that have display screens. Items suchs as tablet computing devices, DVD players and electronic reading devices are some of the items that would be used with this invention.

### BACKGROUND OF THE INVENTION

Items that are available today that are used for carrying various types of articles, such as DVD players, electronic book readers and tablet computing devices, to list but a few, do not allow for the protection, carry, display and full use of the articles. Also, any possible use of such articles while the articles are held within its carrying case is exceedingly cumbersome. Furthermore, the use of articles that have display screens is extremely difficult especially when travelling via various forms of transportation, such as airplanes, buses and cars. Such articles usually must be held within one's hands, on one's lap or on a tray or other fixture which restricts the user's movement and ability to utilize the article in a way that enables maximum productivity. Also, the cases currently available become obsolete once a user decides that he or she no longer has a use for the article for which the case was originally purchased, because the case is usually only suitable for a specific article. As well, cases currently available are usually bulky, heavy and not conducive to the demands of today's commuters and travelers.

### SUMMARY OF THE INVENTION

The present invention is a lightweight protective case that allows users to adhere an article, held within the case, to various surfaces. These surfaces include, but are not limited to: a surface that is covered with fabric, a complementary hook and loop surface or a surface that allows for the affixing of the case's suspension cord. While the case is adhered to or suspended from a particular surface, the user is still able to achieve maximum productivity and utilization of an article even while the article continues to be held within its case. In addition to adhering the article to various surfaces, one can also utilize the case as it holds an article while the case and article are upon a horizontal surface, such as a table or desk. Also an article used with the case can be utilized in a landscape or portrait orientation. The present invention also enables the user to take advantage of many of the features of various articles without having to actually hold on to the article. Furthermore, the present invention can also be used with a variety of articles, thus eliminating the need to purchase multiple cases for various articles. Also, the present invention is bendable and highly flexible.

### BRIEF DESCRIPTION OF THE DRAWINGS

For the purpose of illustrating the invention, there are shown in the drawings forms which are presently preferred; it being understood, however, that this is not limited to the precise arrangements and instrumentalities presented.

FIG. 1 is a view of the closed case with its top closure flap open;

FIG. 2 is a view of the closed case with its top closure flap in the closed position;

FIG. 3 is a view of the interior of the case showing the article placement area;

FIG. 4 is a view of the opposite (back) side of the article placement area of the case and the rear facing side of the hanging flap, which serves as the rear cover and reclining triangle base;

FIG. 5 is a close up view of forward facing side of the hanging flap, which creates the reclining triangle base;

FIG. 6 is a side view of case;

FIG. 7 is a side view of case in a nearly closed position;

FIG. 8 is a side view of hanging flap, which creates reclining triangle base;

FIG. 9 is a side view of hanging flap rolled to create the reclining triangle base;

FIG. 10 is a side view of case as it is used in a vertical orientation and with the hanging flap rolled to create the reclining triangle base;

FIG. 11 is a side view of case as it is used in a horizontal orientation and with the hanging flap rolled to create the reclining triangle base;

FIG. 12 is a perspective view of a bracket;

FIG. 13 is a side view of a bracket;

FIG. 14 is a view of a flat panel display article;

FIG. 15 is a perspective view of a display article with bracket set in place and around near the flat panel display article;

FIG. 16 is a side view of the case with brackets placed upon it;

FIG. 17 is a side view of a display article held within brackets and placed within the article placement area of the open case;

FIG. 18 is a view of passengers seated on an airplane;

FIG. 19 is a view of three passengers on an airplane and one of the passengers utilizing the case;

FIG. 20 is a view of the case containing a display article with both the suspension cord and stabilizing strap affixed;

FIG. 21 is a view of the case as presented in FIG. 13 as the case is affixed to a car seat.

### DETAILED DESCRIPTION OF THE PREFERRED EMBODIMENTS

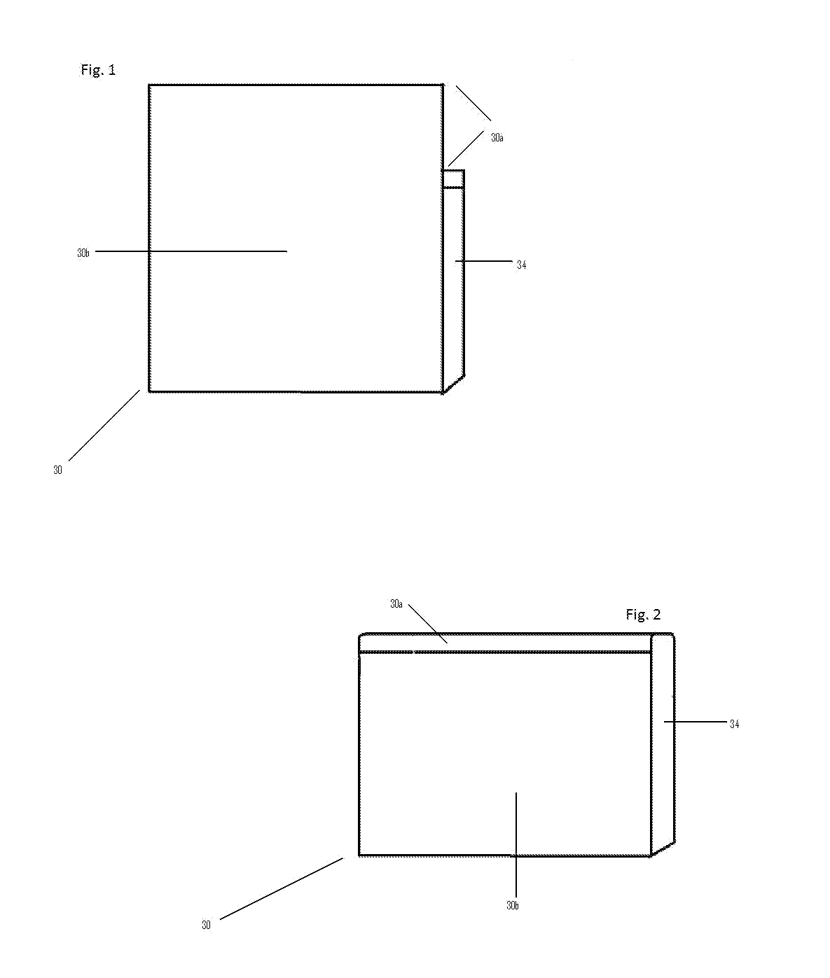

Referring now to the invention in more detail, in FIG. 1 there is shown a perspective view of the exterior portion of the closed case 30 with its top closure flap 30a in the open position. Visible in FIG. 1 are the front exterior cover 30b of the carrying case, the top closure flap 30a and the right side closure flap 30c of the case. The exterior portion of the case can be made using one type or a combination of various types of material, including but not limited to cotton, nylon, vinyl and leather. As presented in FIG. 1, the exterior portion of the case is constructed using vinyl. The case 30 can also be constructed using material of the same type or of different types fused together by methods such as sewing or gluing. Various other options are available when fusing together materials and this invention is not to be limited to any particular method of fusing the portions of the case 30.

Referring now to FIG. 2, shown is a perspective view of the exterior portion of the case 30. Here the top closure flap 30a is in a closed position.

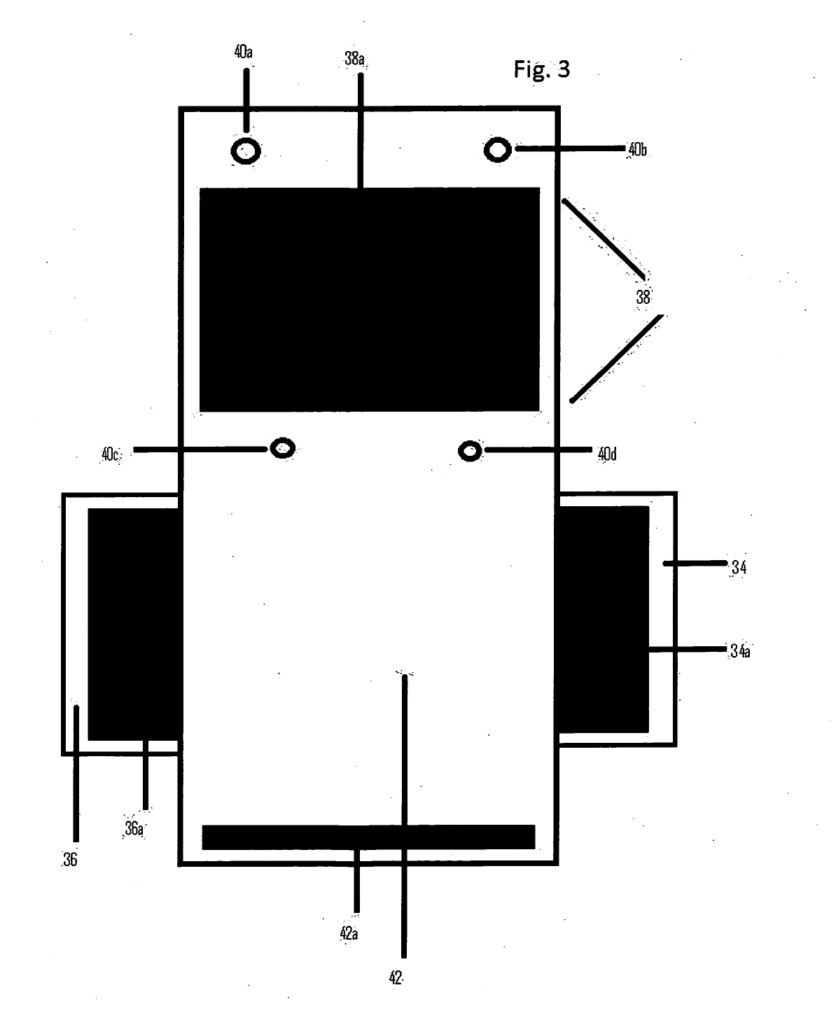

Referring now to FIG. 3, shown is a view of the opened case 30. Here one sees an interior view of the case 30, the suspension cord holes, 40a, 40b and the adjustable stabilizing strap holes 40c, 40d. There are interior views of both the right side closure flap 34 with a hook and loop strip 34a fused to interior side of the right side closure flap 34 and left side closure flap 36 with a hook and loop strip 36a fused to the interior side of the left side closure flap 36, the article placement area 38 with a hook and loop pad 38a fused to the article placement area 38. Also shown, is the interior view of the front cover closure flap 42, which has a hook and loop strip 42a fused to it. Fusing of hook and loop pad 38a, to the article placement area 38 of the case 30, fusing hook and loop strips 34a, 36a to the side closure flaps and fusing of hook and loop strip 42a to the front closure flap 42 can be achieved by various methods, such as sewing, gluing or by employing metal fasteners. The listing of these methods of fusing the hook strips and hook and loop pad to the interior portions of the case 30 is not meant as a limitation regarding the methods utilized when fusing the materials. In this embodiment of the instant invention fusing was achieving by sewing.

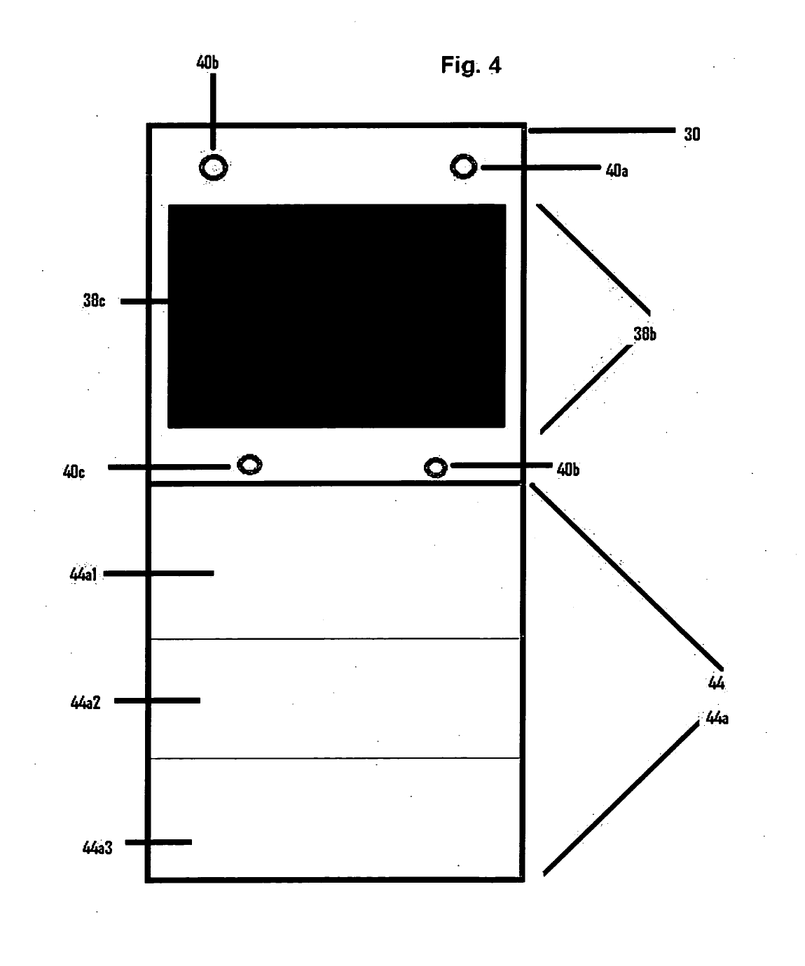

Referring now to FIG. 4, presented is a view of the opposite (back) side of the article placement area 38b of the case 30 and the rear facing side of the hanging lower portion of the case 30 which serves as the rear cover 44 and the reclining triangle base 44a. A hook and loop pad 38c is fused to the back side of the article placement area 38b. As a consequence of the placement of the hook and loop pad 38c, one is able to form a bond between the case 30 and a fabric covered surface, such as the seat on an airplane, bus or car, to name a but a few. The case 30 can also adhere to a complementary hook and loop surface. Upon adhering the case 30 to a surface, one can utilize the article that is held within the case. without having to actually hold onto the article or the case.

Surfaces covered with felt and wool, to name but a few, allow for the formation of a bond and the resulting adhesion. The listing of felt and wool as surfaces for adhesion are not the only types of fabric covered surfaces that allow for adhesion and the instant invention is not to be limited by the listing of the two. Also shown are the holes for the adjustable suspension strap 40a, 40b and the holes for the stabilizing strap 40c, 40d. Fusing of hook and loop pad 38c to the rear side of the article placement area 38b of the case 30 can be achieved by various methods, such as sewing, gluing or by employing metal fasteners. The listing of these methods of fusing the hook and loop pad 38c to the rear side of the article placement area 38b of the case 30 is not meant as a limitation regarding the methods utilized when fusing the materials. In this embodiment of the instant invention fusing was achieved by sewing.

As indicated, the rear cover 44 also serves as a reclining triangle base 44a of the carrying case 30. Inserted between two plies of the material that is used to construct the rear cover 44 are lightweight plastic slats that add rigidity to the rear cover 44. One slat is inserted between each of the plies comprising areas 44a1, 44a2 and 44a3 of the rear cover 44. The listing of plastic slabs is not meant as a limitation regarding the material that can be used. To achieve the desired rigidity, plastic, wood and or metal could be used as well as other suitable materials. In this embodiment of the instant invention plastic was used. The rear cover 44 of the carrying case 30 can be made using various material, such as cotton, vinyl, nylon or leather just to name a few. The listing of these materials, however, is not meant to serve as a limitation as to the materials that can be used. In this embodiment of the instant invention, vinyl was used. The rear cover 44 of the case 30 was fused to the horizontal area approximately a quarter inch below the stabilizing strap holes 40c, 40d. Fusing of the rear cover 44 of the case 30 to this area of the case 30 can be achieved by various methods. such as sewing, gluing or by employing metal fasteners. The listing of these methods of fusing the rear cover 44 of the case 30 to the horizontal area approximately a quarter inch below the stabilizing strap holes 40c, 40d is not meant as a limitation regarding the methods utilized when fusing the materials. In this embodiment of the instant invention fusing was achieved by sewing.

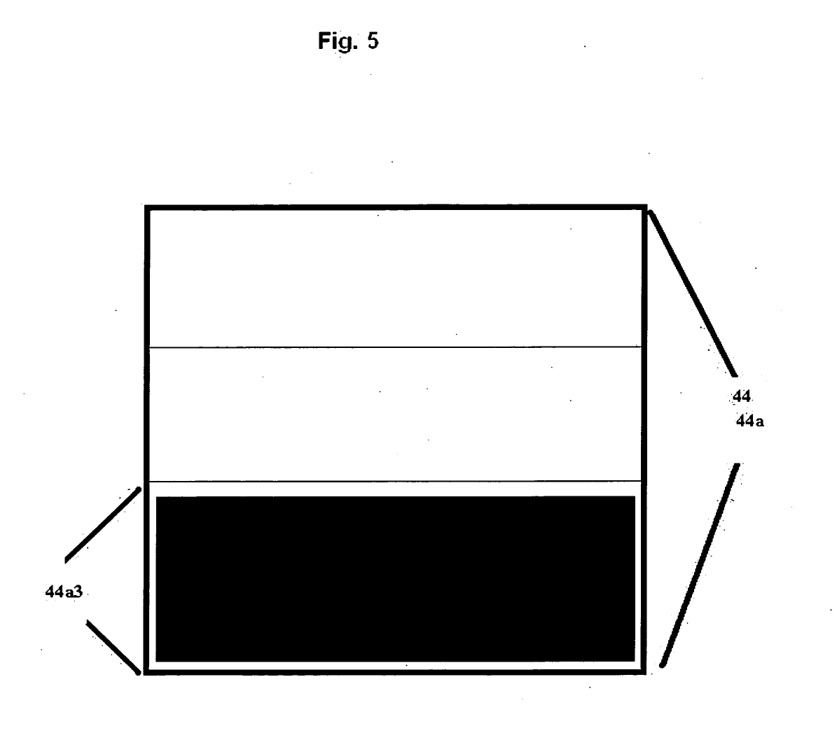

Referring now to FIG. 5, shown is an isolated view of the inner side of the rear cover 44 of the case 30. This is the portion of the case 30 that forms the reclining triangle base 44a of the case when the rear cover 44 is rolled. A hook and loop strip 48 is fused to the lower portion of the inner side of the rear cover 44a3 of the case 30.

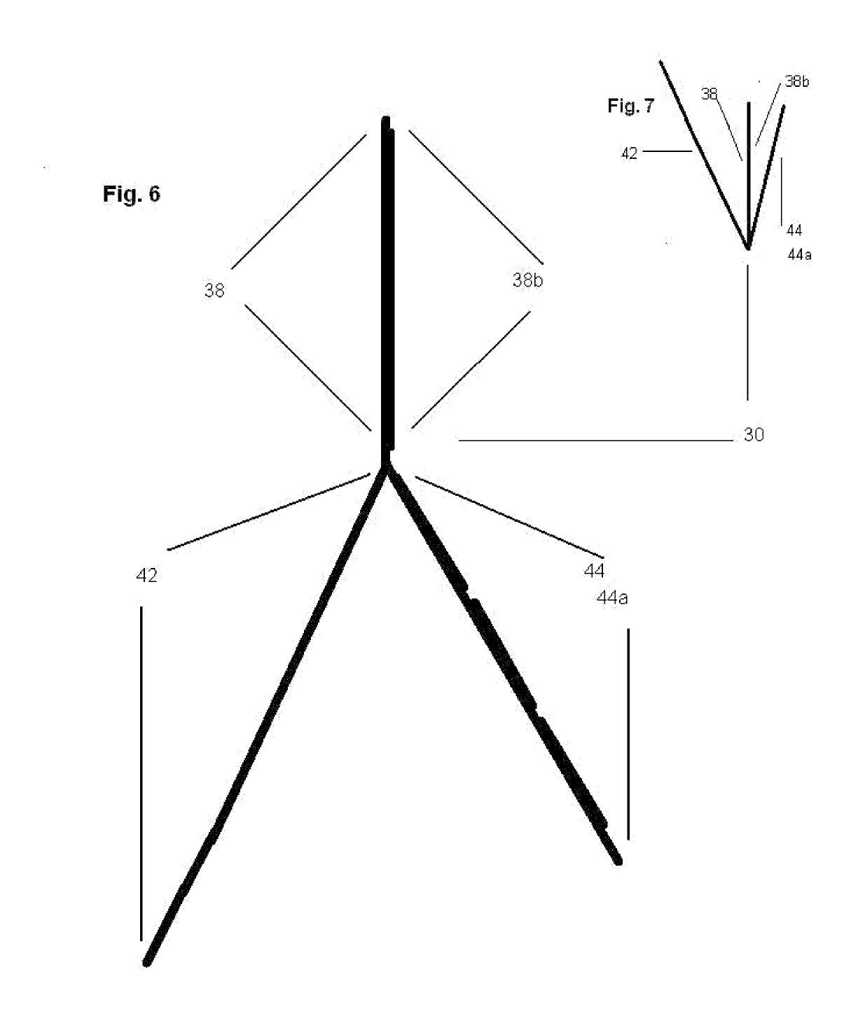

Referring now to FIG. 6, shown is a side view of the open case 30. Here we see a side view of the front cover 42 of the case 30 as it hangs, a side view of the article placement area 38 of the case 30, a side view of the rear cover 44 of the case 30 and a side view of the back side of the article placement area 38b of the case 30. When one wishes to utilize the reclining base 44a, one would roll the rear cover 44 thus forming the reclining base 44a. Also shown is FIG. 7. It presents another side view of the case 30. In this view the front cover 42 and the rear cover 44 are pulled upward in such a way as to depict the case 30 in a nearly closed position.

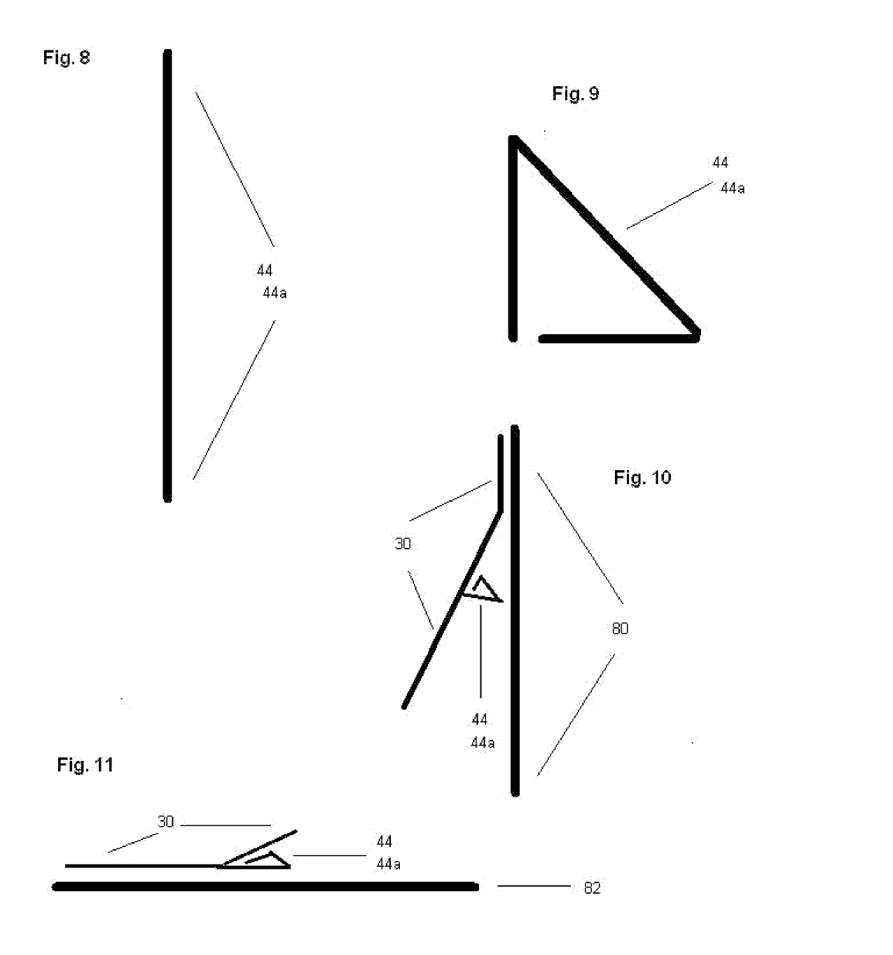

Referring now to FIG. 8, shown is an isolated side view of the rear cover 44 in a hanging position. FIG. 9, on the same page depicts the rear cover 44 as it is rolled so as to create the reclining triangle base 44a. FIG. 10, also shown on the same page, presents the case 30 as it is used to bond the case 30 to a vertical surface 80 with the reclining triangle base 44a being utilized. And finally on the page is FIG. 11, which presents the case 30 being used on a horizontal surface 82. Here the reclining triangle base 44a is also being utilized.

Note that in FIGS. 9, 10 and 11, the triangle reclining base 44a depicts an open triangle, however in use, the triangle would be closed.

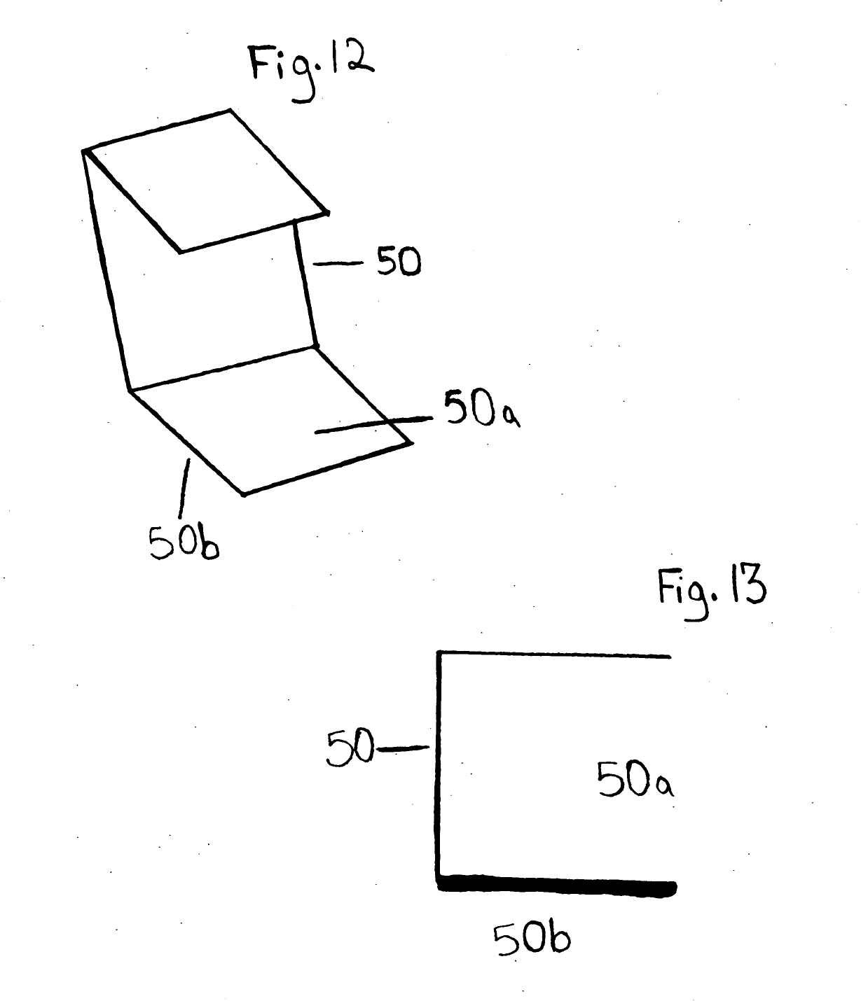

Referring now to FIG. 12 and FIG. 13, there is shown a no-angle bracket 50. FIG. 12 presents a perspective view of ano-angle bracket 50 and FIG. 13 presents a side view that allows one to see the bottom plate 50a of the no- angle bracket 50. This bottom plate 50a of the no-angle bracket 50 is comprised of a hook and loop pad 50b fused to the bottom plate 50a of the no-angle bracket 50. The fusing of the hook and loop pad 50b to the bottom plate 50a of the bracket 50 can be achieved in several ways, such by the gluing, heating, or by using metal fasteners. In this embodiment, fusing was achieved by gluing; however the construction of the instant invention is not to be limited by such a technique. No-angle brackets 50 of various sizes will be manufactured so as to provide appropriate fit for the various types of articles that will be used in conjunction with the present invention. The no-angle brackets 50 can be made from a variety of different materials, such as various types of woods, metals or high strength polymers. These are just a few of the choices in regards to the materials that can be used and the listing of them does not indicate any limitation upon the use of other materials. For this embodiment of the instant invention, no- angle brackets 50 made of metal are used.

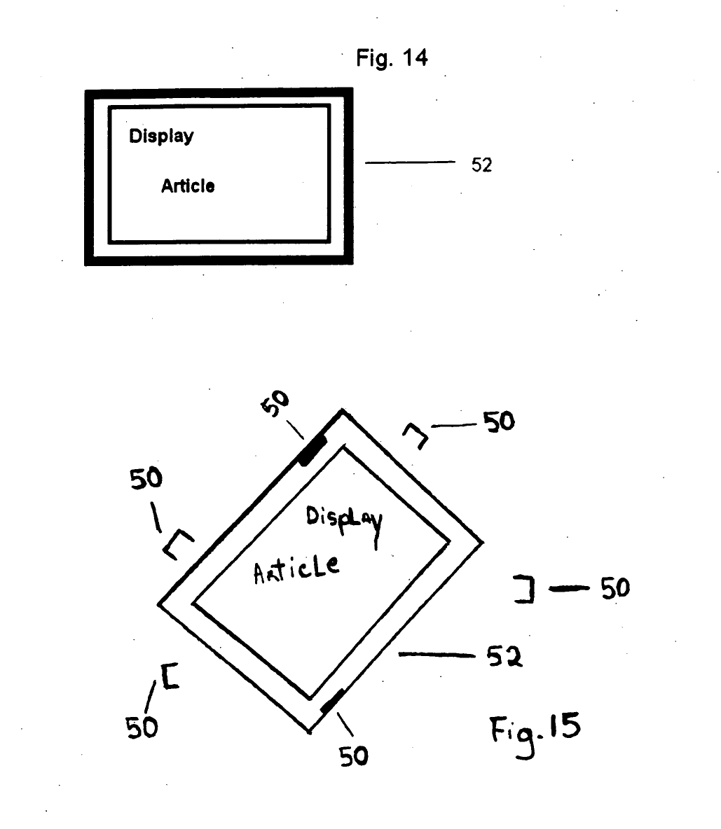

Referring now to FIG. 14, there is generally shown a flat panel display article or more specifically a tablet personal computing article 52. FIG. 15 presents the same article 52; however this presentation of the article 52 shows two no-angle brackets 50 affixed to the article 52 as well as four no-angle brackets 50 surrounding the article 52. The dimensions of this particular article 52 are 8.9×0.75×6.5″. The article 52 weights approximately 1.5 lbs. This article 52 and the information related to it are presented for illustrative purposes only and are not intended as a limitation upon the size, weight, style or brand of a particular article that is to be used with the instant invention. Also a user of the case 30 can use a lesser or greater number of no angle brackets 50 and the user can place the no-angle brackets 50 anywhere upon a particular article (This is not the case with angled brackets. Such as an “L” shaped/90 degree angle bracket) and anywhere within the article placement area 38.

Referring now to FIG. 16, presented is a side view of the case 30. Shown are the front cover 42 of the case 30 as it hangs, the interior article placement area 38 of the case 30 with no-angle brackets 50 in place upon the article placement area 38. The rear side of article placement area 38b can also be seen. Also shown is the rear cover 44 of the case 30, in a hanging position. When the case 30 is not being used, the front cover 42 and the rear cover 44 are folded upward so as to achieve a closed case 30.

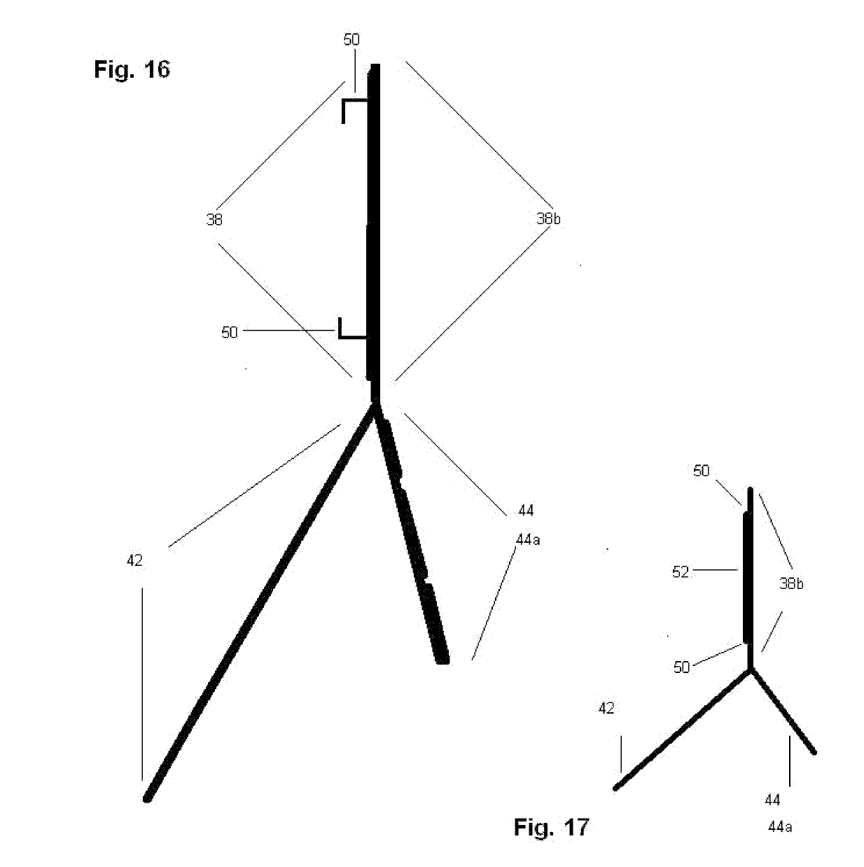

Referring now to FIG. 17, presented is the display article 52 as referred to in FIG. 14. Here the display article 52 is held within no-angle brackets 50 and placed upon an opened case 30. The hook and loop pads 50b, which are fused to the bottom plate 50a of the no-angle brackets 50 and hook and loop pad 38a, which covers the interior article placement area 38 are put in contact with each other and as a result a bond is formed that enables the article 52, as it is held within the no-angle brackets 50, to be securely held within the article placement area 38 of the case 30.

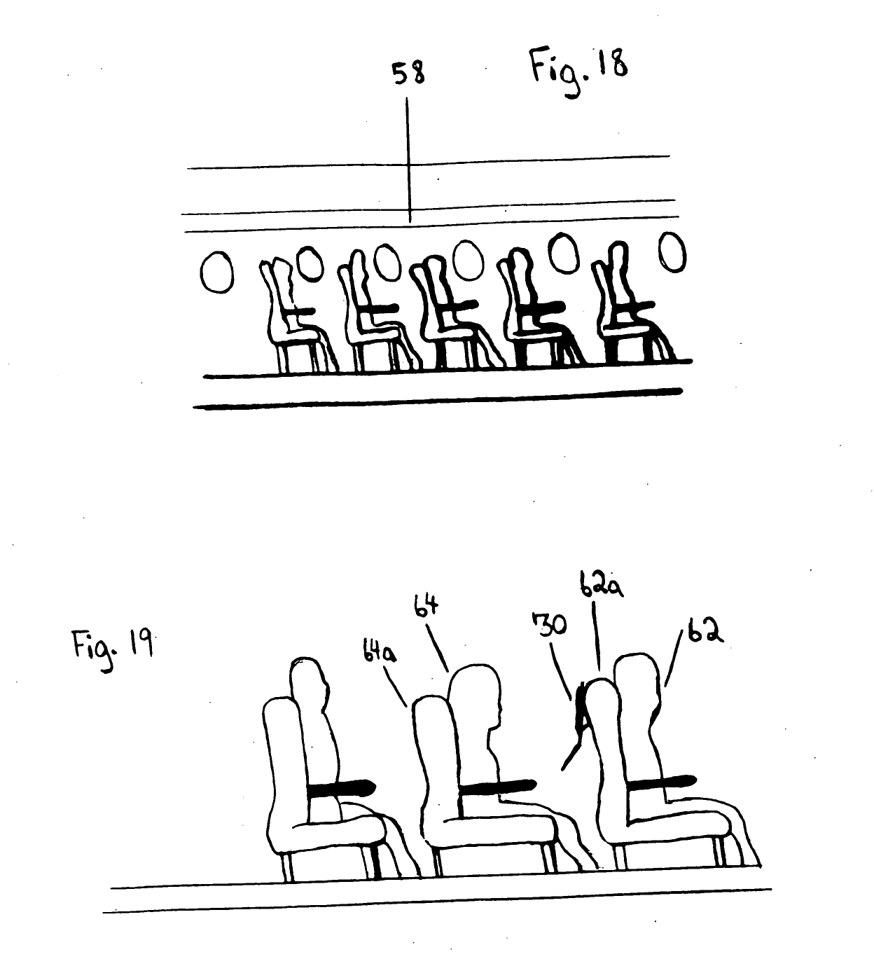

Referring now to FIG. 18 and FIG. 19, shown generally in FIG. 18 are passengers seated within the passenger seating area of an airplane 58. FIG. 19 presents a close up view of three passengers on seated on the plane 58. One passenger 62 is seated in seat 62a. Another passenger 64 is seated in seat 64a. As presented, passenger 64 has adhered the case 30, the instant invention, to the back of a seat 62a. Here the case 30 is in an open position with hook and loop pad 38c, which is fused to the back side of the article placement area 38b of the case 30, making contact with the fabric covered seat 62a. Upon the hook and loop pad 38c coming into contact with the fabric covered seat 62a, a bond is formed that enables the case 30, and the display article 52 that is held with it, to adhere to the seat 62a. The forming of a bond between a surface is not limited to just fabric covered surfaces. Any area that has a hook and look surface can also allow for adhesion.

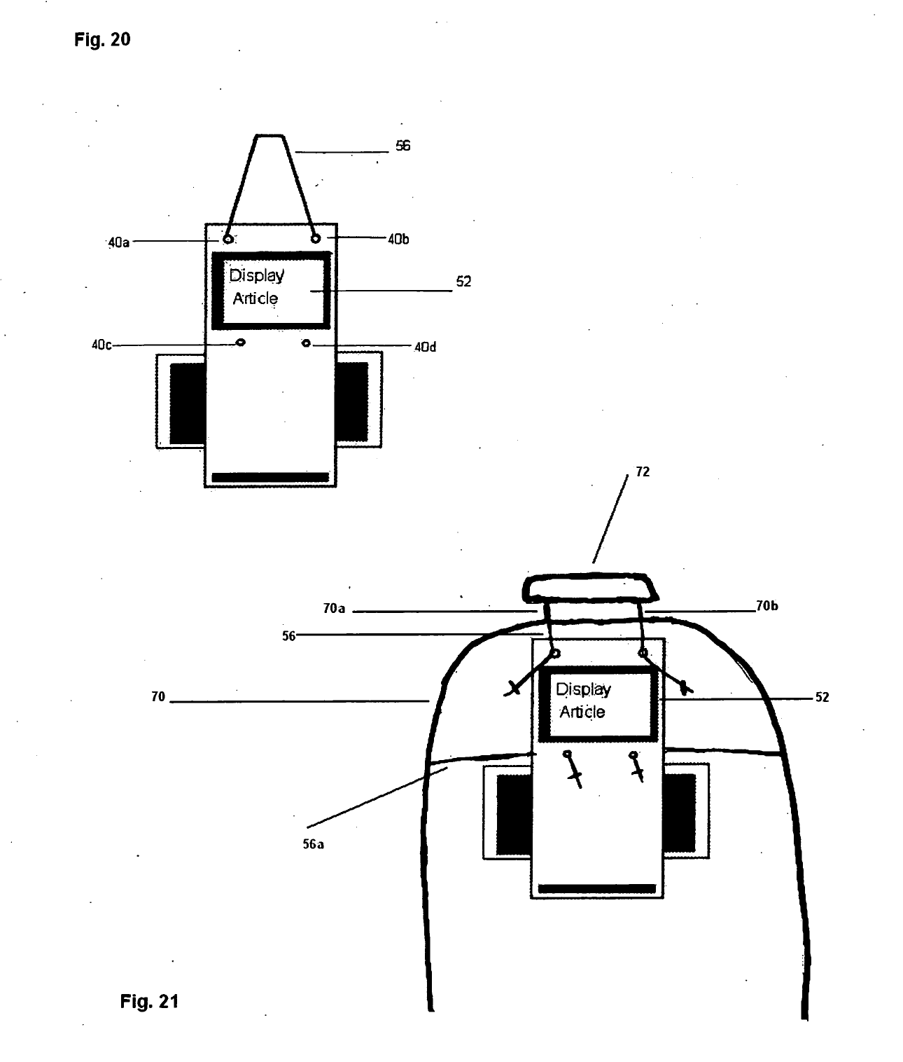

Referring now to FIG. 20, presented is the case 30 as shown in FIG. 3. However, FIG. 20 also shows the suspension cord 56 of the case 30 threaded through the suspension cord holes 40a and 40b. FIG. 20 also shows a display article 52 placed within the interior of the case 30. When using the suspension cord 56 one can suspend the case 30 containing an article, from any item that has an adequate anchor. The suspension cord 56 can made of materials such as cotton, nylon or vinyl. The choices of materials are not to serve as limitations, however. In the embodiment of this invention the suspension cord 56 is made of braided cotton. The cord will be produced in a length of approximately 24 to 30 inches and will be approximately one quarter of an inch in diameter. The suspension cord 56 can be adjusted by tying the suspension cord 56 to make it shorter. These are cited only as examples of how to adhere or suspend the case 30 and are not to serve as limitations of the instant invention.

Referring now to FIG. 21, presented is the case 30 as it is suspended from the headrest 72 posts 70a and 70b of a car seat 70. To allow for more stability one can also apply the stabilizing strap 56a. The stabilizing strap 56a can be adjusted by tying the stabilizing strap 56a to make it shorter. The other elements presented in FIG. 21 are the same as those presented in FIG. 20, along with the additional elements of the car seat 70, the headrest 72 and the headrest posts 70a and 70b.

I claim:

1. A carry and display article comprising of:
a) a base upon which a display device or component can be placed upon;
b) a hook and loop surface substantially covering said base;
c) a hook and loop surface substantially covering the opposite side/back side of said base;
d) two or more no-angle brackets containing hook and loop pads fused to the bottom of the brackets first means for securing display device to said base;
e) a panel that is comprised of rigid sections second means for creating the reclining triangle base and back cover of said carry and display article that is fused along the bottom horizontal portion of said base.

2. A carry and display article as in claim 1, wherein a second panel is fused along the bottom horizontal portion of said base.

3. A carry and display article as in claim 2, wherein a hook and loop strip is fused to and along the bottom portion of said second panel.

4. A carry and display article as in claim 3, wherein left and right closure flaps having hook and loop strips are affixed to said second panel.

5. A carry and display article as in claim 4, wherein hook and loop strips are fused to said back cover of said carry and display article.

6. A carry and display article as in claim 5, wherein suspension cord holes are placed approximately three and a half inches apart and centered at the uppermost portion of said base.

7. A carry and display article as in claim 6, wherein stablizing strap holes are placed approximately four inches apart and centered along the bottom portion of said base.

8. A carry and display article as in claim 7, wherein a suspension cord and a stablizing strap are attached.

9. A carry and display article comprising of:
a) a base upon which a display devise or component can be placed upon;
b) a hook and loop surface substantially covering said base;
c) two or more no-angle brackets containing hook and loop pads fused to the bottom of the brackets first means for securing display device to said base;
d) a panel that is comprised of rigid sections second means for creating the reclining triangle base and back cover of said carry and display article that is fused along the bottom horizontal portion of said base.

10. A carry and display article as in claim 9, wherein a second panel is fused along the bottom horizontal portion of said base.

11. A carry and display article as in claim 10, wherein a hook and loop strip is fused to and along the bottom portion of said second panel.

12. A carry and display article as in claim 11, wherein left and right closure flaps having hook and loop strips are affixed to said second panel.

13. A carry and display article as in claim 12, wherein hook and loop strips are fused to said back cover of said carry and display article.

14. A carry and display article as in claim 13, wherein suspension cord holes are placed approximately three and a half inches apart and centered at the uppermost portion of said base.

15. A carry and display article as in claim 14, wherein stablizing strap holes are placed approximately four inches apart and centered along the bottom portion of said base.

16. A carry and display article as in claim 15, wherein a suspension cord and a stablizing strap are attached.
